(19) United States
(12) Patent Application Publication
(10) Pub. No.: US 2005/0069381 A1
(43) Pub. Date: Mar. 31, 2005

(54) Locking/assembling structure for a pet bed

(76) Inventor: Ching-Hsiung Lin, Taipei (TW)

Correspondence Address: BRUCE H. TROXELL, SUITE 1404, 5205 LEESBURG PIKE, FALLS CHURCH, VA, 22041, US

(21) Appl. No.: 10/673,424

(22) Filed: Sep. 30, 2003

(51) Int. Cl. B25G 3/00

(52) U.S. Cl. 403/243

(57) ABSTRACT

A locking/assembling structure for a pet bed is disclosed. The locking/assembling structure includes a locating plug, a clamping washer and a bolt. One end of the locating plug is formed with an axially extending projection. Multiple annular fastening plates are fitted around the projection. When the projection is fitted into the opening of each end of a transverse tube of the pet bed, the fastening plates tightly abut against inner wall face of the transverse tube to make the locating plug tightly plugged in the end of the transverse tube. The clamping washer is formed with a central through hole. The outer circumference of the clamping washer is formed with two opposite clamping sections which outward axially obliquely extend. The bolt is passed through a through hole of a longitudinal tube of the pet bed and fitted into the through hole of the clamping washer and screwed into the thread hole of the locating plug. When the bolt is screwed into the thread hole, the clamping sections of the clamping washer gradually converge to tightly clamp the longitudinal tube to make the longitudinal tube and the transverse tube more firmly assembled.

### BACKGROUND OF THE INVENTION

The present invention is related to an improved locking/assembling structure for a pet bed, and more particularly to a simple locking/assembling structure which can easily and firmly connect the longitudinal tubes and the transverse tubes of a pet bed.

FIG. 1 shows a conventional pet bed composed of two longitudinal tubes 4, two transverse tubes 41 and a fabric mesh 42. The longitudinal tube 4 is substantially U-shaped. Two ends of the longitudinal tube 4 are bent to form two support legs 40. In addition, the longitudinal tube 4 is formed with transverse through holes 401 near the support legs 40. The transverse tube 41 is a straight tube. A plug 411 is fitted in the opening of each end of the transverse tube 41. The plug 411 is formed with a central thread hole 412. When assembled, bolts 3 are passed through the through holes 401 of the longitudinal tubes 4 and fitted into tray-shaped washers 5 and then screwed into the thread holes 412 of the transverse tubes 41 to form a frame. The support legs 40 of the longitudinal tubes 4 are supported on the ground to space the frame from the ground by a certain height. The fabric mesh 42 is tensely laid in the frame for a pet such as a cat or a dog to sleep thereon. The above conventional pet bed has some shortcomings in use as follows:
1. The circumference of the longitudinal tube 4 is arched so that the tray-shaped washer 5 can be hardly snugly attached to the longitudinal tube 4. As a result, after the transverse tube 41 is combined with the longitudinal tube 4, the assembly has poor integration strength and tends to swing. In case a kid jumps and plays on the pet bed, an accident may take place.
2. When fitting the plug 411 in the opening of the transverse tube 41, it is necessary to make the thread hole 412 of the plug 411 parallel to the opening of the transverse tube 41. In addition, in the case that the plug 411 is a full cylindrical body, the plug 411 can be tightly fitted in the opening of the transverse tube 41. However, it will be difficult to fit the plug into the opening. On the other hand, in order to facilitate plugging of the plug into the opening, the plug 41 can be tapered and co-used with a wedge plate. In this case, it is easier to fit the plug into the opening. However, the tightness will be insufficient and the plug is apt to loosen and detach.

### SUMMARY OF THE INVENTION

It is therefore a primary object of the present invention to provide a locking/assembling structure for a pet bed. The locking/assembling structure includes a locating plug, a clamping washer and a bolt. The locating plug is plugged in an opening of each end of a transverse tube of the pet bed. The locating plug is formed with a central thread hole extending from one end of the other end of the locating plug. The clamping washer is formed with a central throughhole. The outer circumference of the clamping washer is formed with at least two opposite clamping sections which outward axially obliquely extend. The bolt is passed through a through hole of a longitudinal tube of the pet bed and fitted into the through hole of the clamping washer and screwed into the thread hole of the locating plug. The clamping sections of the clamping washer hold and clamp outer wall of the longitudinal tube. When the bolt is screwed into the thread hole, the clamping sections of the clamping washer gradually converge to tightly clamp the longitudinal tube to make the longitudinal tube and the transverse tube more firmly assembled.

It is a further object of the present invention to provide the above locking/assembling structure for the pet bed, in which one end of the locating plug is formed with an axially extending projection. Multiple annular fastening plates are fitted around the projection. When the projection is fitted into the opening of each end of a transverse tube of the pet bed, the fastening plates tightly abut against inner wall face of the transverse tube to make the locating plug tightly plugged in the end of the transverse tube.

The present invention can be best understood through the following description and accompanying drawings wherein:

### BRIEF DESCRIPTION OF THE DRAWINGS

FIG. 1 is a perspective view of a conventional pet bed;

FIG. 2 is a perspective exploded view of the locking/assembling structure for the pet bed of the present invention;

FIG. 3 is a perspective assembled view of the locking/assembling structure for the pet bed of the present invention; and

FIG. 4 is a sectional assembled view of the locking/assembling structure for the pet bed of the present invention.

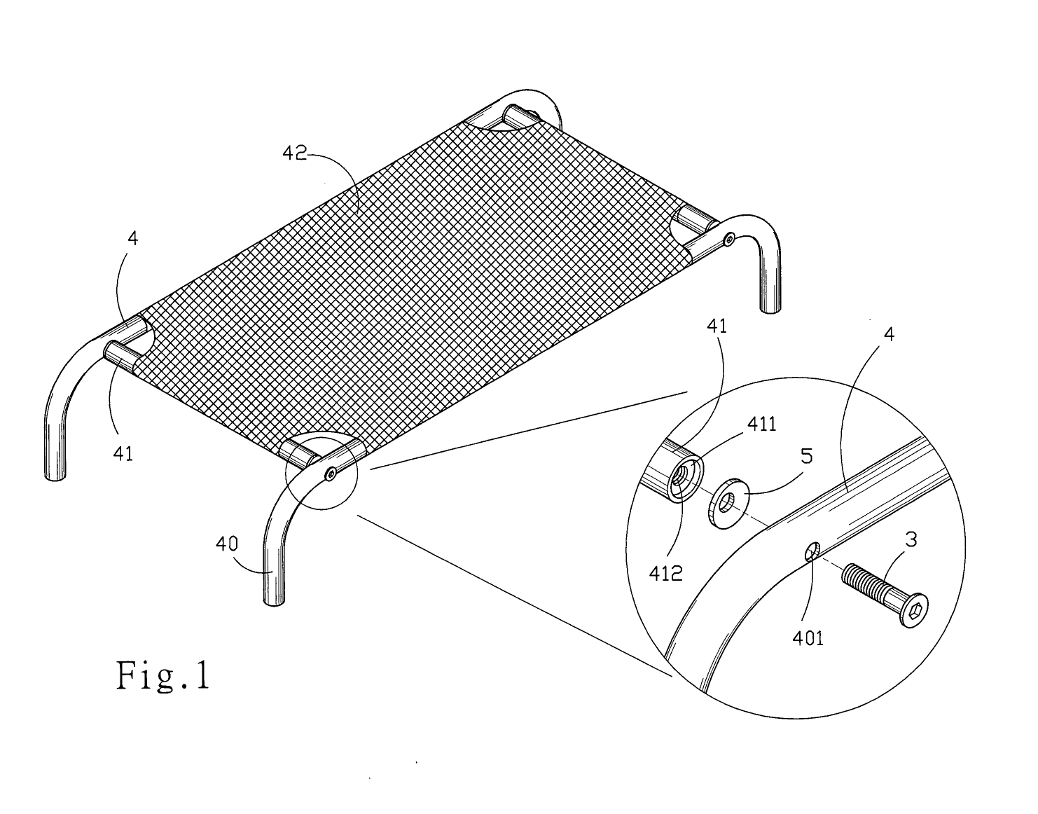

### DETAILED DESCRIPTION OF THE PREFERRED EMBODIMENT

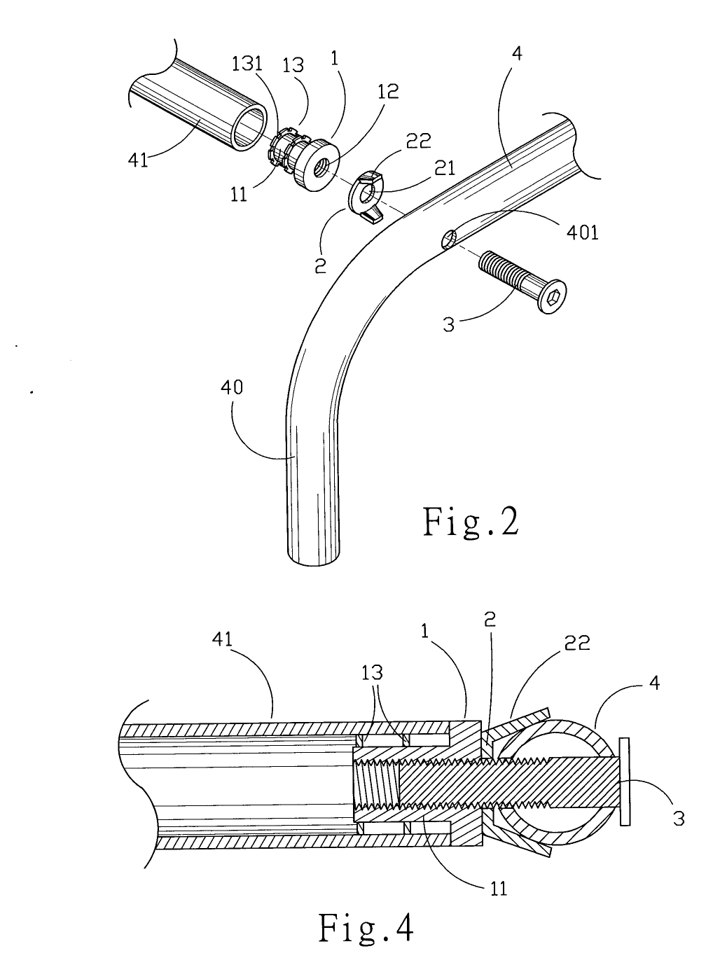

Please refer to FIG. 2. The present invention includes a locating plug 1, a clamping washer 2 and a bolt 3. One end of the locating plug 1 is formed with an axially extending projection 11. Multiple annular fastening plates 13 are fitted around the projection 11. The circumference of each fastening plate 13 is formed with multiple notches 131. The locating plug 1 is formed with a central thread hole 12 extending from one end of the other end of the locating plug 1. The clamping washer 2 is formed with a central through hole 21. The outer circumference of the clamping washer 2 is formed with two opposite clamping sections 22 which outward axially obliquely extend.

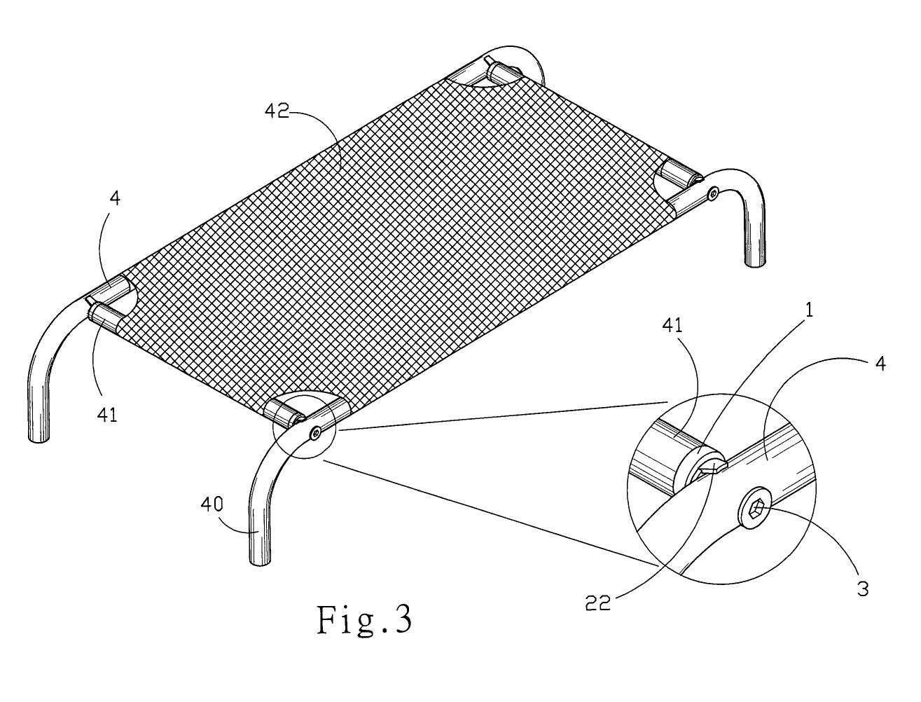

Referring to FIGS. 3 and 4, when assembled, the projection 11 of the locating plug 1 is plugged into the opening of each end of the transverse tube 41 of the pet bed. At this time, the fastening plates 13 tightly abut against the inner wall face of the transverse tube 41 at multiple points. The notches 131 can resiliently absorb the slight deformation of the compressed fastening plates 13. Therefore, the locating plug 1 can be tightly and firmly fitted in the end of the transverse tube 41. Then, the bolt 3 is passed through the through hole 401 of the longitudinal tube 4 and fitted into the through hole 21 of the clamping washer 2 and screwed into the thread hole 12 of the locating plug 1. Accordingly, the longitudinal tubes 4 and the transverse tubes 41 are connected to form a frame of the pet bed. Finally, a bed face 42 such as a fabric or a mesh is laid in the frame. The support legs 40 of the longitudinal tubes 4 are supported on the ground to space the bed face 42 from the ground by a certain height for a cat or a dog to sleep on the bed face 42.

In the above structure, when the bolt 3 pushes the longitudinal tube 4 to abut against the clamping washer 2, the middle section of the clamping washer 2 is compressed to make the two clamping sections 22 gradually converge to tightly clamp the longitudinal tube 4 without deflection. Therefore, the longitudinal tubes 4 and the transverse tubes 41 are more firmly durably assembled without swinging or loosening.

The above embodiment is only used to illustrate the present invention, not intended to limit the scope thereof. Many modifications of the above embodiment can be made without departing from the spirit of the present invention.

1. A locking/assembling structure for a pet bed, comprising:
a locating plug, one end of the locating plug being formed with an axially extending projection for plugging into an opening of each end of a transverse tube of the pet bed, the locating plug being formed with a central thread hole extending from one end of the other end of the locating plug;
a clamping washer formed with a central through hole, an outer circumference of the clamping washer being formed with at least two opposite clamping sections which outward axially obliquely extend; and
a bolt passed through a through hole of a longitudinal tube of the pet bed and fitted into the through hole of the clamping washer and screwed into the thread hole of the locating plug, the clamping sections of the clamping washer holding and clamping outer wall of the longitudinal tube, whereby when the bolt is screwed into the thread hole, the clamping sections of the clamping washer gradually converge to tightly clamp the longitudinal tube to make the longitudinal tube and the transverse tube more firmly assembled.

2. The locking/assembling structure for the pet bed as claimed in claim 1, wherein multiple annular fastening plates are fitted around the projection of the locating plug for tightly abutting against inner wall face of the transverse tube at multiple points.

3. The locking/assembling structure for the pet bed as claimed in claim 2, wherein a circumference of each fastening plate is formed with multiple notches.
